(19) United States
(12) Patent Application Publication
(10) Pub. No.: US 2016/0283247 A1
(43) Pub. Date: Sep. 29, 2016

(54) APPARATUSES AND METHODS TO SELECTIVELY EXECUTE A COMMIT INSTRUCTION

(71) Applicant: Intel Corporation, Santa Clara, CA (US)

(72) Inventors: Girish Venkatasubramanian, Sunnyvale, CA (US); Ethan Schuchman, Santa Clara, CA (US); David Keppel, Seattle, WA (US); Sebastian Winkel, Los Altos, CA (US); David N. Mackintosh, Mountain View, CA (US); Jaroslaw Topp, Schoeppenstedt (DE)

(21) Appl. No.: 14/668,605

(22) Filed: Mar. 25, 2015

(51) Int. Cl. G06F 9/38

(52) U.S. Cl. CPC G06F 9/3842; G06F 9/3861; G06F 9/3836

(57) ABSTRACT

Methods and apparatuses relating to selectively executing a commit instruction. In one embodiment, a data storage device stores code that when executed by a hardware processor causes the hardware processor to perform the following: translating an instruction into a translated instruction to be executed by the hardware processor, marking a commit instruction one of for execution and for optional execution by the hardware processor, and including a hint for a commit instruction marked for optional execution; and a hardware commit unit to determine if the commit instruction marked for optional execution is to be executed based on the hint.

### TECHNICAL FIELD

The disclosure relates generally to electronics, and, more specifically, an embodiment of the disclosure relates to the selective execution of a commit instruction.

### BACKGROUND

A processor, or set of processors, executes instructions from an instruction set, e.g., the instruction set architecture (ISA). The instruction set is the part of the computer architecture related to programming, and generally includes the native data types, instructions, register architecture, addressing modes, memory architecture, interrupt and exception handling, and external input and output (I/O). It should be noted that the term instruction herein may refer to a macro-instruction, e.g., an instruction that is provided to the processor for execution, or to a micro-instruction, e.g., an instruction that results from a processor's decoder decoding macro-instructions.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a system to selectively execute a commit instruction according to embodiments of the disclosure.

FIG. 2 illustrates a system to selectively execute a commit instruction according to embodiments of the disclosure.

FIG. 3 illustrates a flow diagram of selectively executing a commit instruction according to embodiments of the disclosure.

FIG. 4 illustrates a software flow diagram of selectively executing a commit instruction according to embodiments of the disclosure.

FIG. 5 illustrates a hardware flow diagram of selectively executing a commit instruction according to embodiments of the disclosure.

FIG. 6A is a block diagram illustrating both an exemplary in-order pipeline and an exemplary register renaming, out-of-order issue/execution pipeline according to embodiments of the disclosure.

FIG. 6B is a block diagram illustrating both an exemplary embodiment of an in-order architecture core and an exemplary register renaming, out-of-order issue/execution architecture core to be included in a processor according to embodiments of the disclosure.

FIG. 7A is a block diagram of a single processor core, along with its connection to the on-die interconnect network and with its local subset of the Level 2 (L2) cache, according to embodiments of the disclosure.

FIG. 7B is an expanded view of part of the processor core in FIG. 7A according to embodiments of the disclosure.

FIG. 8 is a block diagram of a processor that may have more than one core, may have an integrated memory controller, and may have integrated graphics according to embodiments of the disclosure.

FIG. 9 is a block diagram of a system in accordance with one embodiment of the present disclosure.

FIG. 10 is a block diagram of a more specific exemplary system in accordance with an embodiment of the present disclosure.

FIG. 11, shown is a block diagram of a second more specific exemplary system in accordance with an embodiment of the present disclosure.

FIG. 12, shown is a block diagram of a system on a chip (SoC) in accordance with an embodiment of the present disclosure.

FIG. 13 is a block diagram contrasting the use of a software instruction converter to convert binary instructions in a source instruction set to binary instructions in a target instruction set according to embodiments of the disclosure.

### DETAILED DESCRIPTION

In the following description, numerous specific details are set forth. However, it is understood that embodiments of the disclosure may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

A (e.g., hardware) processor (e.g., having one or more cores) may execute instructions to operate on data, for example, to perform arithmetic, logic, or other functions. Code (e.g., software) to be executed on a processor may be translated from one format to another format. A (e.g., dynamic) binary translator may be utilized to translate code (e.g., an instruction) from one format to another format. A binary translator may translate code (e.g., an instruction) from a guest format to a host format. A binary translator may translate an instruction of a first ISA into an instruction of a second ISA. A binary translator may translate (e.g., an x86 format) macro-instruction(s) into micro-instruction(s). An instruction may translate into a plurality of translated instructions, e.g., a one-to-one correspondence is not required in one embodiment. Multiple instructions may translate into one translated instruction or a number of translated instructions that is less than the number of multiple (e.g., untranslated) instructions, e.g., a one-to-one correspondence is not required in one embodiment. A binary translator may translate a software instruction (e.g., in binary code) into a hardware instruction (e.g., in binary code), for example, for execution on a hardware processor. A (e.g., dynamic) binary translator may include hardware, software, firmware, or any combination thereof. A dynamic binary translator (DBT) may translate one instruction (e.g., in source binary code complying with the architecture of a source processor (source architecture)) into a translated instruction (e.g., into target binary code complying with the architecture of a target processor (target architecture)). The dynamic binary translation process may take place during execution of the source binary code (e.g., at run time).

Code may include one or more commit instructions. A commit (e.g., the action caused by the execution of a commit instruction) may generally refer to the saving (e.g., commitment) of changes to the architectural state of a processor made during execution of a section of code (e.g. instructions), for example, without any errors. A commit instruction encountering an error may cause the commit instruction not to execute the commit action, but may cause a rollback, e.g., to a previously saved architectural state (e.g., commit point). In one embodiment, a rollback action is caused by the execution of a rollback instruction.

Commit instructions may present a barrier to software and/or hardware optimizations involving (e.g., hardware-based) dynamic Out-of-Order (OoO) instruction reordering. In one embodiment, when software schedules commit instruction(s), they may reduce the window size available for the hardware OoO mechanism, e.g., performance may be degraded. Commit instructions may impose an (e.g., significant) overhead to observing cache coherence. In one embodiment, avoiding commit instructions may improve the performance and/or reduce the power consumption of executing workloads. Certain dynamic binary translation systems with software scheduling (e.g., where software schedules commit instructions) may result in a reduction in the window available in which OoO scheduling of instructions may be performed, e.g., potentially degrading the performance. Instruction commit (e.g., and rollback) semantics may present a barrier to hardware-based dynamic scheduling of instructions OoO and/or extracting maximum parallelism (e.g., instructions executing in parallel). In certain multi-core processors, commit instructions may impose the requirement that all pending memory operations are globally observed to guarantee memory consistency which may impose a performance overhead. Depending on implementation, commit instructions may involve blocking of data cache access which may cause a performance penalty. Performing a commit (e.g., executing a commit instruction) may cost power and cause a power overhead. Avoiding commits may potentially improve the power and energy efficiency of a processor. Longer commit windows may allow more aggressive reclamation and reuse of registers, e.g., limitations on register reuse due to live-outs may be reduced if the number of commits are fewer.

In certain embodiments, not eliding commits may allow a minimized (e.g., relatively small) commit window, e.g., one instruction. In one embodiment, a commit window includes ten(s) of instructions. In another embodiment, a commit window may include hundred(s) of instructions. In yet another embodiment, a commit window may be less than ten instructions. Commits may not be elided (e.g., commits may be required to execute) when execution is to be aborted from transactional code (e.g., due to exceptions, the abort may be initiated after a commit is executed, e.g., as an atomic-region boundary). In one embodiment, a processor may abort at any commit point (e.g., as for interrupts). In one embodiment, a processor may abort at the most recent commit, for example, when a fault occurs within an atomic region such that the architectural (e.g., machine) state may be rolled back to the immediately preceding commit before aborting execution. The execution of the instructions may be restarted from the rolled-back commit point, for example, in a manner which allows the precise state to be constructed, e.g., for interrupts and/or exceptions. An (e.g., longer) uncommitted (e.g., and over-utilized) region of code may increase the chance of speculative (e.g., shadowing) state resources being utilized. For example, when this happens, the processor may rollback to the beginning of the uncommitted region of code and break it up (e.g., statically or dynamically) into smaller commit windows and may re-execute the smaller commit windows. In one embodiment, a processor may allow up to N stores to be performed in one transaction. The number of stores executed may depend on the path through the code, e.g., a conditional branch taken or not-taken may execute some code within the transaction which executes more or fewer stores than some other path. If the dynamic path through the code reached a commit without exceeding N, then the commit may proceed. Otherwise an exception may be generated. The cost of a rollback may be proportional to the distance by which the state is rolled back, e.g., the larger the commit window is, the greater the rollback distance and the greater the rollback penalty. In one embodiment where the rollback penalty is pure overhead, having the smallest amount of rollback distance may be desirable and committing (e.g., frequently) may reduce the rollback distance and conversely, a larger commit window may causes larger performance overheads. Thus, in certain embodiments, the optimum number of commits (or size of commit window) may be (e.g., highly) dynamic and statically predicting when to execute a commit instruction (e.g., commit) and when to not execute a commit instruction (e.g., elide a commit) may be avoided. In one embodiment, if an instruction faults multiple times (e.g., frequently), the commit window (e.g., the interval between commits) may be a single instruction. In another embodiment, dynamic binary translation may be applied when the execution profile for instructions is not known (e.g., it may be desirable to expedite the binary translation so code may be executed soon), and the commit window may be every about 5-10 instructions.

In one embodiment of this disclosure, a commit unit (e.g., of a processor) and a dynamical binary translator (e.g., of a processor) may be utilized to selectively execute a commit instruction. In one embodiment, a hardware and software co-designed dynamic binary translation (DBT) processor may dynamically ignore (e.g., elide) certain commits that were to be executed on the processor, for example, in both with-ROB and without-ROB designs (e.g., while supporting precise exception semantics). The dynamic binary translator (DBT) (e.g., software) may mark commit instruction(s) that are candidates to not be executed (e.g., for elision) with a hint. The hardware processor (e.g., based on its architectural state at execution) may use these hints and elide marked commit instructions. In certain embodiments of a ROB-less DBT processor of this disclosure, precise exception semantics may be maintained while supporting commit instruction elision.

In one embodiment of this disclosure, the decision, e.g., by a commit unit (e.g., logic), to execute or not execute a commit instruction marked (e.g., by the dynamic binary translator) with a hint may be based on more than the current state of the processor (such as the resource utilization, outstanding memory operations, instructions since last commit, and pending interrupts). For example, the decision to execute or not execute a commit instruction may be based on a section of (e.g., future) code that is to-be-executed (e.g., code that contains multiple speculative memory operations). One embodiment of this disclosure provides a hint for a commit instruction to provide the processor (e.g., hardware) with information about the future (e.g., atomic) region of code which is about to begin. The processor may use this hint's information in addition or alternatively to the information about the current state (e.g., the resource utilization, outstanding memory operations, instructions since last commit, and pending interrupts) to make a decision (e.g., according to an algorithm) as to whether a commit instruction is to be elided or not. In one embodiment, a DBT processor without a ROB, but that allows for OoO commits, may support precise exception (e.g., fault) semantics while supporting commit elision.

In one embodiment of a dynamic binary translator (DBT) based processor with instruction and memory atomicity semantics in the form of commit instructions, one approach to simplify the design is to eliminate the ReOrder Buffer (ROB), which on certain OoO processors may be used to ensure that instructions retire in-order. In a DBT processor without a ROB, instructions may be allowed to retire immediately after execution when the instruction writes its result(s) back to the physical register file (000 retirement). Instructions that are issued from the reservation stations may either complete execution and retire or incur a fault and be re-executed (e.g., replayed). In a processor without a ROB with OoO retirement, precise state may be available (e.g., only) at commit points, for example, such that any fault which occurs in a commit region cannot be precisely associated with the architectural state at which the fault occurred. One possible solution in such machines may be to support precise-exception semantics using a separate in-order execution mode. However, such an in-order mode may be (e.g., much) slower than the default out-of-order mode. Not executing (e.g., eliding or changing to a NOP) commit instructions may require more resources in such machines as it may increase the uncommitted window of instructions that need to be re-executed (e.g., replayed) in-order.

In one embodiment, a system according to this disclosure may dynamically determine (e.g., choose) to elide certain commits based either on a pure hardware state or through software hints provided by a hardware and software co-design. A dynamic binary translator (DBT) may indicate that certain commit instructions in a stream of instructions (e.g., code) may not be executed (e.g., may be elided or skipped). In one embodiment, a system according to this disclosure may provide a hint within a commit instruction (e.g., as a field thereof) to allow the hardware (e.g., commit unit) to determine the likelihood of speculation overrun or cost of rollback. For example, based on the tradeoff of the benefit of eliding the commit instruction to the cost of rollback, the hardware may dynamically determine to elide a commit instruction or to execute it. This determination may be configurable via certain control registers. In one embodiment when the commit instruction is executed, the system ensures that (e.g., all) instructions from all previous elided commit regions are retired before the next commit region is executed. Moreover, in an embodiment of a DBT processor which does not have a ROB, this disclosure provides several embodiments to emulate precise exceptions while still supporting eliding of commits In one embodiment, these mechanisms may rely on the ability to rollback to the last commit point and re-execute the region which faulted after configuring the machine to temporarily operate in-order and/or with non-optional commits, for example, using a pure hardware processor or a hardware and software co-designed processor.

In one embodiment of a hardware and software co-designed processor, software may specify commit instructions which may be skipped. The software may provide hints to the hardware, e.g., regarding the possibility of requiring a rollback and the cost of such rollback to facilitate the hardware in deciding whether to not execute (e.g., elide) or to execute that commit instruction. Additionally or alternatively, (e.g., DBT) software may provide a hint for commit instructions which provide the hardware processor with information about a to-be-executed (e.g., future) region, e.g., an atomic region which is about to begin execution. Hardware (e.g., processor) may decide to elide the commit instructions marked for optional execution by the software (e.g., at run-time) or ignore the marking and execute (e.g., take) the commit In one embodiment, hardware and/or software may include a re-execution unit or module, e.g., for execution aborting situations such as, but not limited to, maintaining precise exceptions. The processor may be switched into an in-order mode and precise exception semantics may be observed. Several example options for not executing (e.g., eliding) or executing (e.g., taking) a commit instruction encountered during the re-execution of the rolled-back instructions are discussed herein. In certain embodiments, the (e.g., software-generated) hint(s) may allow the hardware (e.g., processor) to avoid speculation-overrun faults (e.g., which may be caused by aggressively eliding commits) better than when compared to not including such a hint in the determination to execute or not execute a commit instruction. In certain embodiments, precise exceptions on a ROB-less DBT machine with OoO retirement support optional commits

Certain embodiments of this disclosure may use a (e.g., dynamic) binary translator to translate an instruction into a translated instruction to be executed by a hardware processor. A (e.g., dynamic) binary translator may include hardware, software, firmware, or any combination thereof. A (e.g., dynamic) binary translator may mark a (e.g., each) commit instruction as either for execution (e.g., mandatory) or for optional execution by the hardware processor, for example, by including an indication as a field in the commit instruction. A (e.g., dynamic) binary translator may include a hint for a commit instruction marked for optional execution. A hint may generally refer to information utilized (e.g., tested and/or evaluated) to determine if the optional commit instruction is to be executed or not executed (e.g., elided). A hint may be a field of a commit instruction (e.g., a hint corresponding to a commit instruction or a future commit instruction) or in a separate data structure. In one embodiment, a hardware commit unit of a processor is to determine if the commit instruction marked for optional execution is to be executed based on the hint. A commit unit may be hardware, software, firmware, or any combination thereof. A commit instruction may be included in the original (e.g., untranslated) code, e.g., then translated into a translated commit instruction. Software or a DBT may insert the commit instruction into a stream of instructions for execution.

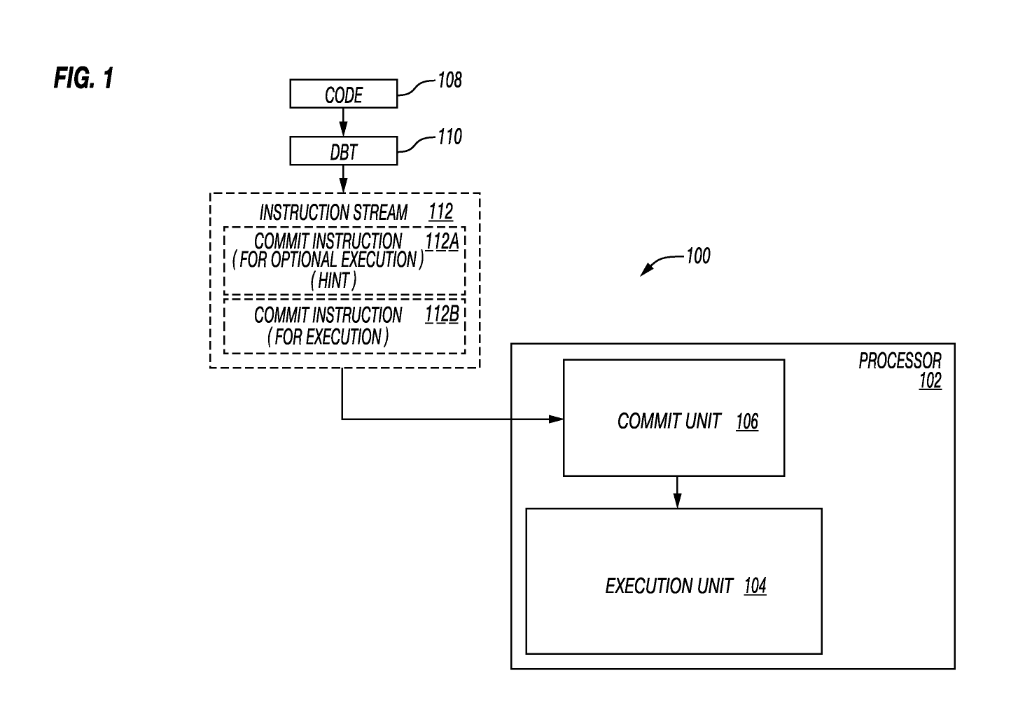

FIG. 1 illustrates a system 100 to selectively execute a commit instruction according to embodiments of the disclosure. Depicted processor 102 includes an execution unit 104 (e.g., as part of a core) and a commit unit 106. A multiple-core processor may have a single commit unit for each core or the entire processor may have a single commit unit. Commit unit may be part of an execution unit or other component of a processor. Code (e.g., binary code) 108 may be translated (e.g., by dynamic binary translator (DBT) 110) from a first (e.g., untranslated) format to a second (e.g., translated) format. DBT may be in hardware, software, firmware, or a combination thereof. In one embodiment, an instruction stream (e.g., translated instruction stream 112) may be output from DBT 110. A commit instruction 112A of the instruction stream 112 may be marked for optional execution, e.g., along with a hint. A commit instruction 112B of the instruction stream 112 may be marked for (e.g., mandatory) execution, e.g., with or without a hint. DBT may mark a commit instruction from the code 108 as (i) “for execution” or (ii) “for optional execution”, e.g., as an input for the commit unit 106. DBT may add the hint for the commit instruction 112A marked for optional execution. DBT (e.g., an algorithm thereof) may base the hint on one or more instructions that are being translated (e.g., a future section of code) before execution of those instructions by the processor 102. For example, a future section of code may include non-transactional data (e.g., user input, such as, but not limited to, user input from a keyboard) followed by a commit instruction. The DBT may mark that commit instruction as “for execution” (e.g., for mandatory execution), for example, to avoid losing non-transactional data. For example, a future section of code may include transactional data followed by a commit instruction. The DBT may mark that commit instruction as “for optional execution”, e.g., to allow the hardware processor (e.g., commit unit) to determine if that commit instruction is executed or not. DBT may output a commit instruction (e.g., 112A or 112B) to the commit unit 106. Commit unit may pass a commit instruction 112B marked for execution to a component for execution, e.g., depicted as an execution unit 104. In one embodiment, commit unit may pass a commit instruction (e.g., 112A or 112B) for execution to a (e.g., hardware) scheduler to schedule execution. A commit instruction for execution may be marked by the DBT for execution. A commit instruction to be executed may be marked by the DBT with a hint for optional execution and the commit unit may determine to execute that commit instruction. Transactional data may include data stored in data registers and/or memory. A processor may include hardware to support commit (e.g., and rollback) of data registers and/or memory, as well as other resources. In certain embodiments, a non-transactional resource may be used transactionally, e.g., that resource may be written by a transaction before it is read, and if it is written outside of transactions before it is read, then the behavior may be transactional.

A single headed arrow herein may not be limited to one-way communication, for example, it may indicate two-way communication (e.g., both to and from that component).

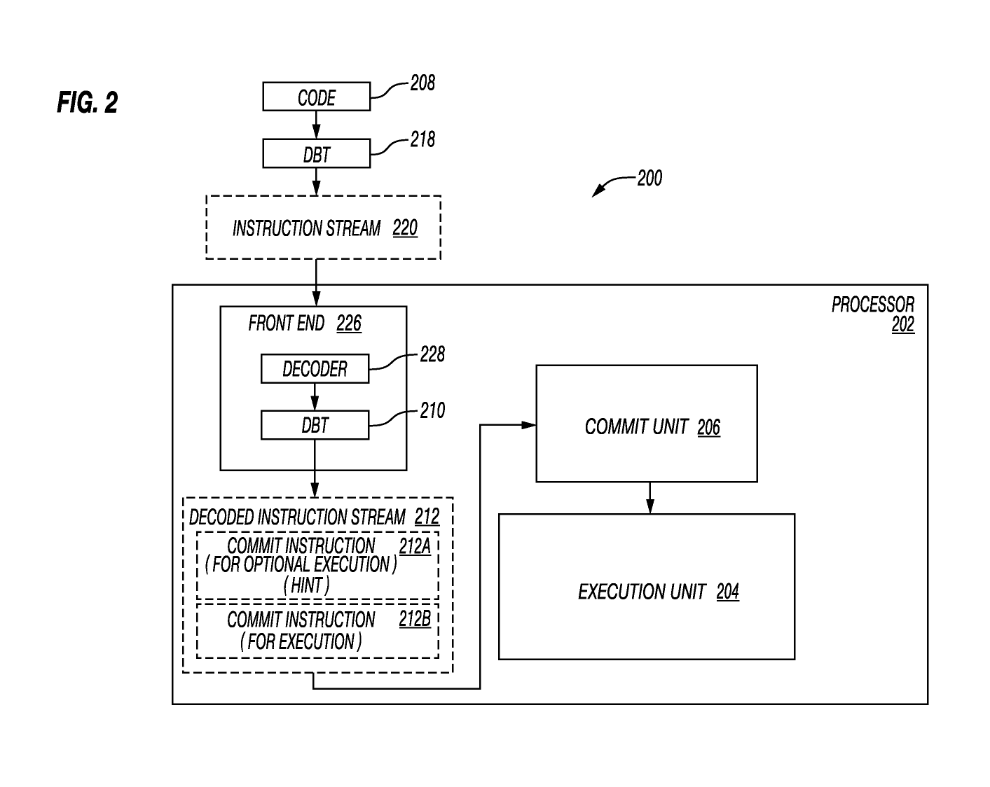

FIG. 2 illustrates a system 200 to selectively execute a commit instruction according to embodiments of the disclosure. Depicted processor 202 includes an execution unit 204 (e.g., as part of a core) and a commit unit 206. A multiple-core processor may have a single commit unit for each core or the entire processor may have a single commit unit. Commit unit may be part of an execution unit or other component of a processor.

Code (e.g., binary code) 208 may be compiled (e.g., by a compiler 218), for example, code 208 may be source code (e.g., written in a programming or source language) and compiler may translate the source code into another computer language (e.g., the target machine language). Compiler may output a compiled instruction (e.g., as instruction stream 220). Code 208 may include one or more commit instructions.

An instruction (e.g., of instruction stream 220) may be output to the processor 202, e.g., a front end 226 of the processor 202. Front end 226 may fetch and prepare instructions to be used by other components of processor 202. Processor may include a dynamic binary translator (DBT) as a separate component (not shown) or as a component of front end 226, e.g., as depicted in FIG. 2. Front end 226 may include a decoder 228 (e.g., an instruction decoder to decode an instruction into the control signals (e.g., micro-instructions) to control the execution of the instruction). Decoder may output decoded code (e.g., a decoded instruction) to a binary translator (e.g., DBT 210 of processor 202). Binary translator (e.g., DBT 210) may translate an instruction (e.g., from instruction stream 220) from a first (e.g., untranslated) format to a second (e.g., translated) format.

In one embodiment, an instruction stream (e.g., translated, decoded instruction stream 212) may be output from DBT 210. A translated commit instruction 212A of the decoded instruction stream 212 may be marked for optional execution, e.g., along with a hint. A translated commit instruction 212B of the decoded instruction stream 212 may be marked for (e.g., mandatory) execution, e.g., with or without a hint. DBT may mark a commit instruction (e.g., from the code 208) as (i) “for execution” or (ii) “for optional execution”, e.g., as an input for the commit unit 206. DBT may add the hint for the commit instruction 212A marked for optional execution. DBT (e.g., an algorithm thereof) may base the hint on one or more instructions that are being translated (e.g., a future section of code) before execution of those instructions by the processor 202. For example, a future section of code may include non-transactional data (e.g., user input, such as, but not limited to, user input from a keyboard) followed by a commit instruction. The DBT may mark that commit instruction as “for execution”, e.g., to avoid losing the non-transactional data. For example, a future section of code may include transactional data followed by a commit instruction. The DBT may mark that commit instruction as “for optional execution”, e.g., to allow the hardware processor (e.g., commit unit) to determine if that commit instruction is executed or not. DBT may output a commit instruction (e.g., 212A or 212B) to the commit unit 206. Commit unit may pass a commit instruction 212B marked for execution to a component for execution, e.g., depicted as an execution unit 204. In one embodiment, commit unit may pass a commit instruction (e.g., 212A or 212B) for execution to a (e.g., hardware) scheduler to schedule execution. A single headed arrow herein may not be limited to one-way communication, for example, it may indicate two-way communication (e.g., both to and from that component). Although a cache is not depicted in certain of the Figures, a cache (e.g., an instruction and/or data cache), may be utilized. Although use of a DBT is discussed in certain embodiments, a transaction scheduler or other component may be utilized. For example, if a processor has instruction (e.g., x86) level ISA support for transactions, embodiments of this disclosure may improve the performance for workloads by eliding commits (e.g., in non-DBT processors for which traditional compilers use an ISA exposed feature of marking commits as optional). A dynamic reduction in execution of commit instructions (e.g., in contrast to executing all of the commit instructions in code) may increase performance due to more instruction level parallelism (ILP) extracted from an (e.g., larger) atomic region and/or lower power consumption.

A section of code may include multiple commit instructions (e.g., interspersed with non-commit instructions). Certain commit instructions may be marked as for execution (e.g., non-optional), for example, as discussed herein. In one embodiment, code includes a region which cannot be rolled back (e.g., because of non-speculative operations or use non-shadowed resources) and the commit instructions therein and/or following that region (in program order) may be marked (e.g., by a DBT) for execution.

Certain commit instructions may be marked for optional execution, e.g., as discussed herein. For commit instructions which are marked as optional, hardware (e.g., commit unit of a processor) may decide (e.g., at or immediately prior to execution time) whether or not to elide them. The hardware may make this decision (e.g., at least in part) based on more than the current state of the machine (e.g., more than the number of outstanding memory operations, instructions pending for execution, instructions since the last commit, pending interrupts, etc.). In one embodiment, hardware may choose to not elide (e.g., chose to execute) a commit instruction to avoid speculation overruns, for example, due to a commit being elided just before a region which contains (e.g., multiple) speculative memory operations. Certain embodiments of this disclosure provide (e.g., extra) hints to commit instructions to provide the hardware processor (e.g., commit unit) information about a future (e.g. atomic) region which is about to begin execution on the processor. A hint may be embedded within the commit instruction itself (e.g., occupying (unused) opcode or operand bits) or as an additional paired hint instruction (e.g., a commit instruction and its hint instruction to provide the hint for that commit instruction to the processor). In one embodiment, a DBT (e.g., software) may know the contents of an (e.g., each) atomic region previous to or following a commit instruction and may embed information about that region along with the commit instruction itself.

Examples of hint(s) to provide include, but are not limited to, (i) the number of instructions in the atomic region, e.g., to ensure that the hardware does not exceed a maximum-instructions-between-commits control register value, (ii) the number of memory accesses (e.g., load and store operations) in the region, e.g., to avoid faults where the hardware speculation resources are exhausted (for example, hardware may combine this hint with the currently used speculation resource value to determine whether the region will cause an overrun, to force the commit to occur), and (iii) the likelihood of a rollback being required, e.g., for regions which frequently fault, a DBT may embed a hint which causes hardware to alter its (e.g., default) decision making process and more heavily bias towards execution of the commit In one dynamic embodiment, a DBT may detect a region that encounters multiple (e.g., repeated) rollbacks and mark the associated commit instructions for that region for (e.g., mandatory) execution. In one embodiment, an atomic region may generally refer to a region between two (e.g., executed) commits More generally, some transactional systems may include a “transaction start” indicator and a “transaction commit” indicator and a rollback may revert state to the point of the “transaction start” but not before that point (e.g., even if “transaction start” was not paired with a commit) One embodiment of this disclosure may execute under “transactions” (e.g., not using both a start and a commit) to use “transaction commit” as the indicator for the next transaction start.

A further embodiment disclosed herein is the manner in which commits may be marked as optional. A commit instruction may occur before each atomic region begins (e.g., at the head of each region), for example, where the DBT determines that the next region after the commit instruction is not to be elided, such as, but not limited to, the next region using non-speculative resources or containing some other operation which is not to be rolled back. In such an embodiment, marking that leading commit for execution (e.g., as non-optional with the DBT) may not guarantee the data for this region is not lost, e.g., since the next commit instruction may still be elided, and so the entire region (e.g., and the subsequent one) may be rolled back.

In one embodiment, control flow within a unit of translation is known at compilation time by the DBT system, but flow between units of translation is not statically determined. As such, the DBT in such an embodiment may not guarantee that the commit which follows the region is marked as for execution (e.g., non-optional). One embodiment herein may be to embed a hint along with a commit instruction to ensure the next (e.g., in program order) commit instruction is executed (e.g., is not elided). Hardware (e.g., commit unit of a processor) may cache this hint, for example, in an internal register of the processor (e.g., commit unit) and use the value to cause (e.g., require) execution of the next commit instruction, e.g., independent of that next commit instruction's hint. In one embodiment, a region to not be rolled back may mark (e.g., with a DBT) a commit instruction at (or near) the end of the region as to be executed (e.g., non-optional). In certain embodiments, the number of instructions may not be changed during this process, e.g., when the hint is encoded as a part of the commit instruction itself.

One embodiment of this disclosure supports precise exceptions while supporting optional commits in ROB-less DBT processor. Regarding precise exceptions, generally there may broadly be two categories: (i) asynchronous interrupts may be delivered at any precise point, for example, so they are simply delayed until the next commit instruction at which point they are delivered in a precise manner (e.g., the presence of a pending interrupt may override the hardware commit-elision logic and forces the next commit to occur) and (ii) for synchronous faults on a system which does not deliver precise exceptions (e.g., other than when executing in a special in-order mode), one embodiment disclosed is as follows. On detection of a non-precise fault, the code may be rolled back to the last executed commit instruction. Executed (e.g., taken) commits may ensure that the commit regions before (e.g., immediately prior to) the commit instruction are executed and retired before the commit instruction itself. At this point, execution may be restarted with the processor configured to operate in-order and with non-optional commits The fault may now occur in a precise manner and may be handled accordingly.

A block of instructions may be re-executed after a rollback, e.g., a rollback instruction executed by a processor. A block of instructions previously executed Out-of-Order (OoO) may be re-executed in program order after a rollback, e.g., a rollback instruction executed by a processor. The handling of commits during a re-execution of a rolled-back instruction(s) may be handled according to a policy such as, but not limited to one or more of the following: (i) the processor (e.g., hardware) may track the number of elided commits in a register and following a rollback, this value from the register may be used to determine the number of commits that should be executed in a non-optional manner (e.g., taken and not elided), for example, to ensure that the reproduced fault has no elided commits preceding it, e.g., this may ensures that the optional nature of commits is functionally transparent to the DBT (e.g., software), (ii) the re-execution following a rollback (e.g., caused by a fault) may be be performed in-order so that the reproduced issue (e.g., fault) is delivered in a precise manner, but, for example, when only a small (e.g., less than about 1, 2, 3, 4, 5, 6, 7, 8, or 9) number of commits have been elided, this approach may be efficient, but when large (e.g., more than about 10, 11, 12, 13, 14, 15, 20, 25, etc.) number of commits were elided, the amount of time spent executing in-order may become excessive, e.g., when in-order execution is much slower than Out-of-Order execution) and in these situations the exception may be isolated in two passes (for example, first, a rollback may be executed and then execution may begin again with optional commits forced to be taken (e.g., forced to commit), but still out-of-order and secondly, if the fault occurs again, there may be no elided commit instructions preceding it, so rolling back and re-executing in-order may replay (e.g., at most) one atomic region, e g , minimizing the in-order overhead), and (iii) on a fault and/or rollback, elide N−1 commits (where N is the number of elided commits, e.g., as tracked by the hardware register described above) and force the taking of the Nth commit, where this may be achieved by copying the number of elided commits from the hardware register to a down counter and forcing a commit when the counter counts down from one to zero. In one embodiment, these algorithms may be driven completely by hardware (e.g., transparent to DBT software) or using a hardware and software co-designed processor. Hardware may vector to a special exception vector to indicate the occurrence of a non-precise fault. Additionally, hardware may provide status registers to indicate the number of commits elided thus far. DBT (e.g., software) may explicitly issue a rollback instruction, and may write a separate control register to force overriding of commit optionality hints and/or force in-order execution mode. In one embodiment, the hardware may track other (e.g., non-hint) information which it combines with hints. For example, hardware may track the number of instructions executed since the last executed commit instruction. In one embodiment, on discovery (e.g., execution) of an optional commit: if that number of executed instructions exceeds a maximum value (e.g., 100 or more), the commit may not be elided; if that number of executed instructions is less than a minimum value (e.g., less than 20), the commit may be skipped (e.g., even if the next region is large); and if that number of executed instructions is between the minimum value and maximum value (e.g., between 20 and 100), the commit may not be skipped when there is a hint the next region exceeds a maximum number of instructions and skipped when the hint indicates the next region is less than the maximum number.

Embodiments for marking commits as optional or non-optional and using these markings are as follows. DBT (e.g., software) may mark commits as optional when it considers it appropriate to do so and non-optional when not. If a commit (e.g., instruction) follows certain operations that are only to be done once, that commit may be marked as non-optional. If a commit precedes or follows a region where non-shadowed resources are live-in and live-out, that commit may be marked non-optional. If a commit precedes a highly speculative region, that commit may be marked as non-optional to reduce the uncommitted window. DBT (e.g., software) may provide hints as to the cost of rolling back the upcoming (e.g., future) atomic region, for example, as the software may view portions of the code before the hardware does. DBT (e.g., software) may provide hints as to the required speculation resources to successfully execute the upcoming (e.g., future) atomic region. DBT (e.g., software) may provide hints as to the likelihood of a rollback being executed following the atomic region, e.g., based on observed dynamic information. DBT (e.g., software may configure hardware thresholds for maximum allowable rollback cost or probability.

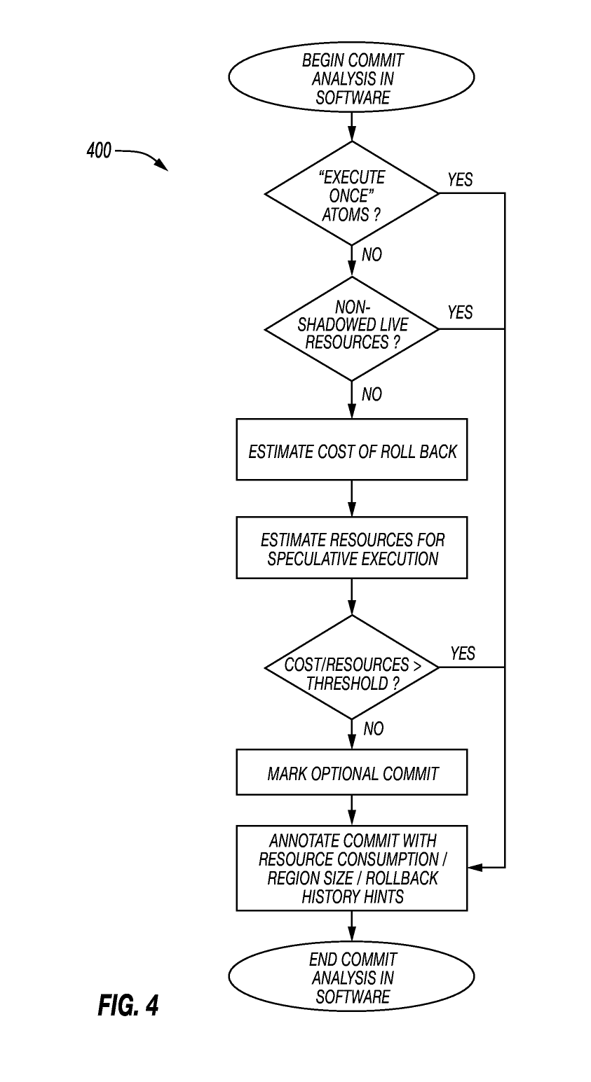

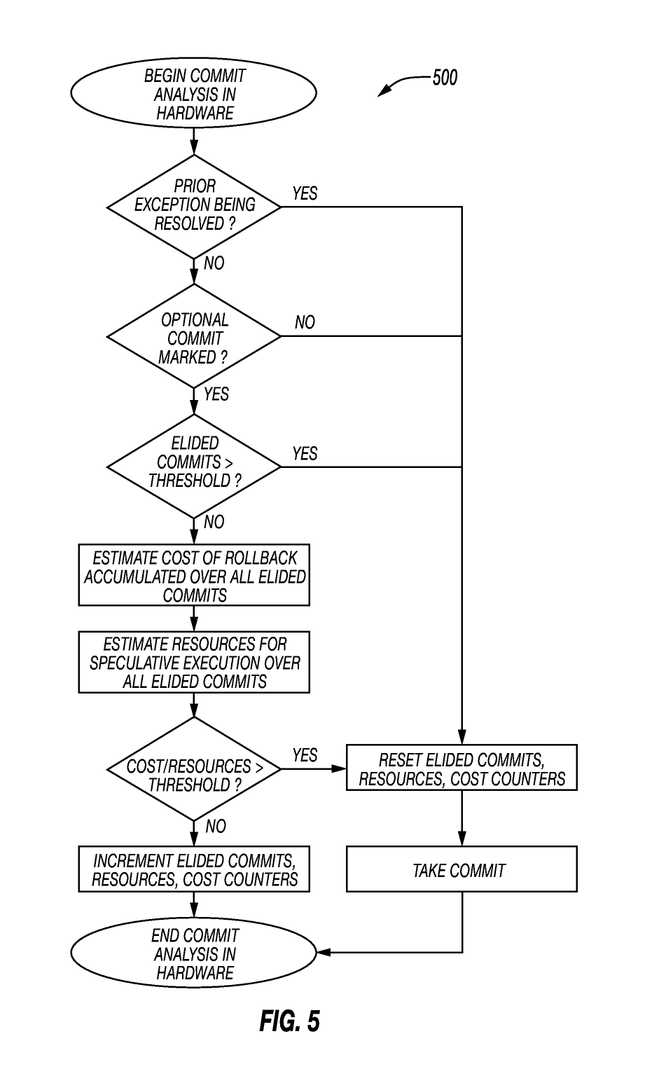

Hardware (e.g. commit unit of a processor) may cause the execution (e.g., take) of a commit instruction when one or more of the following occur: if the commit is marked as non-optional, if the commit is marked as optional and the speculative resources available are exceeded by the resource consumption hint in the commit, if the commit is marked as optional and the uncommitted number of instructions exceed a threshold, if the commit is marked as optional and the number of elided commits exceed a threshold, if an exception has occurred, or if replaying the rolled back instructions and, depending on the type of commit eliding policy used for rollback-replay, e.g., as discussed above, any commit in the replayed region for policy (i) or (ii) or the final commit among the N commits in the rolled back region for policy (iii). Exemplary algorithms are shown in FIGS. 4-5.

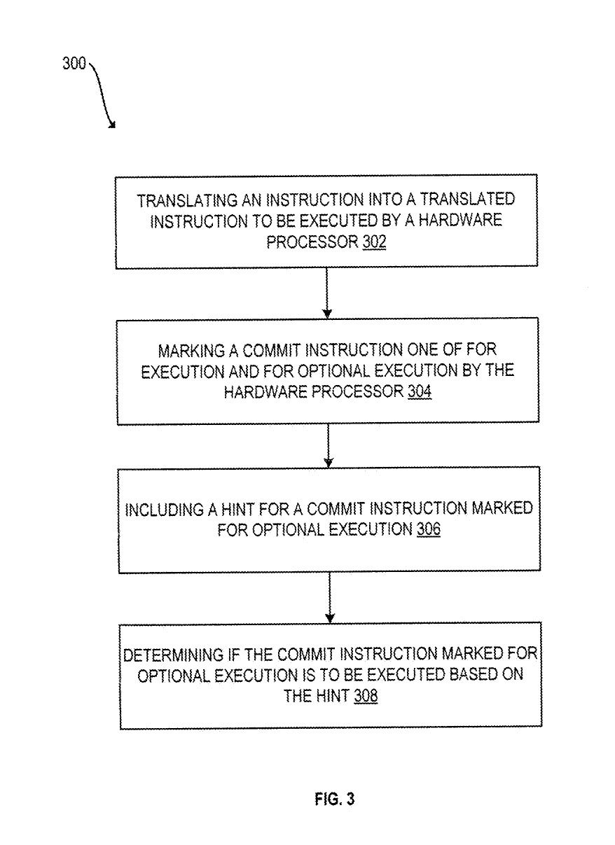

FIG. 3 illustrates a flow diagram 300 of selectively executing a commit instruction according to embodiments of the disclosure. Depicted flow diagram includes translating an instruction into a translated instruction to be executed by a hardware processor 302, marking a commit instruction one of for (e.g., mandatory) execution and for optional execution by the hardware processor 304, including a hint for a commit instruction marked for optional execution 306, and determining if the commit instruction marked for optional execution is to be executed based on the hint 308 (and optionally, also based one or more of other factors, e.g., see FIG. 5). FIG. 4 illustrates a software flow diagram 400 of selectively executing a commit instruction according to embodiments of the disclosure. FIG. 5 illustrates a hardware flow diagram 500 of selectively executing a commit instruction according to embodiments of the disclosure. In one embodiment, “prior exception being resolved?” may refer to an embodiment where there was an exception (e.g., fault) previously which gave rise to re-execution of the current commit instruction. A system according to this disclosure may utilize both flow diagrams 400 and 500. For example, a software DBT may utilize the flow diagram of FIG. 4. For example, a hardware processor (e.g., commit unit) may utilize the flow diagram of FIG. 5.

If an exception (e.g., fault) occurs, a processor may re-execute the faulting code, but on re-execution the cause of the exception may have been resolved (e.g., some other core may have changed the memory so there is no longer a fault on re-execution). One embodiment may avoid being in a mode where all optional commits are not skipped. An example mechanism is a counter which may track the number of skipped commits since the last non-skipped commit On re-execution, no commits may be skipped, and the number of commits may be tracked by a second counter. If the second counter exceeds the count of skipped commits from the first execution, then the exception may be considered resolved and the processor may resume (e.g., selectively) skipping optional commits

In one embodiment, an apparatus includes a hardware binary translator to translate an instruction into a translated instruction to be executed by a hardware processor, mark a commit instruction one of for execution and for optional execution by the hardware processor, and include a hint for a commit instruction marked for optional execution, and a hardware commit unit to determine if the commit instruction marked for optional execution is to be executed based on the hint. The translated instruction may follow or proceed the commit instruction in program order. The hardware commit unit may cause a next commit instruction to be executed based on the hint for the commit instruction. The hardware binary translator may include the hint as a field of the commit instruction marked for optional execution. The hardware commit unit may cause a block of instructions executed out of order before a rollback action to be executed in order after the rollback action. The hardware commit unit may cause all commit instructions marked for optional execution of the block of instructions to be executed independently of their hint after the rollback action.

In another embodiment, an apparatus includes a data storage device that stores code that when executed by a hardware processor causes the hardware processor to perform the following: translating an instruction into a translated instruction to be executed by the hardware processor, marking a commit instruction one of for execution and for optional execution by the hardware processor, and including a hint for a commit instruction marked for optional execution, and a hardware commit unit to determine if the commit instruction marked for optional execution is to be executed based on the hint. The translated instruction may follow or proceed the commit instruction in program order. The data storage device may further store code that when executed by the hardware processor causes the hardware processor to perform the following: causing a next commit instruction to be executed based on the hint for the commit instruction. The data storage device may further store code that when executed by the hardware processor causes the hardware processor to perform the following: wherein the including comprises including the hint as a field of the commit instruction marked for optional execution. The data storage device may further store code that when executed by the hardware processor causes the hardware processor to perform the following: causing a block of instructions executed out of order before a rollback action to be executed in order after the rollback action. The data storage device may further store code that when executed by the hardware processor causes the hardware processor to perform the following: causing all commit instructions marked for optional execution of the block of instructions to be executed independently of their hint after the rollback action.

In yet another embodiment, a method includes translating an instruction into a translated instruction to be executed by a hardware processor, marking a commit instruction one of for execution and for optional execution by the hardware processor, including a hint for a commit instruction marked for optional execution, and determining if the commit instruction marked for optional execution is to be executed based on the hint. The translated instruction may follow or proceed the commit instruction in program order. The method may further include causing a next commit instruction to be executed based on the hint for the commit instruction. The method may further include including the hint as a field of the commit instruction marked for optional execution. The method may further include causing a block of instructions executed out of order before a rollback action to be executed in order after the rollback action. The method may further include causing all commit instructions marked for optional execution of the block of instructions to be executed independently of their hint after the rollback action.

In another embodiment, an apparatus includes a hardware processor, and a data storage device that stores code that when executed by the hardware processor causes the hardware processor to perform the following: translating an instruction into a translated instruction to be executed by the hardware processor, marking a commit instruction one of for execution and for optional execution by the hardware processor, including a hint for a commit instruction marked for optional execution, and determining if the commit instruction marked for optional execution is to be executed based on the hint. The translated instruction may follow or proceed the commit instruction in program order. The data storage device may further store code that when executed by the hardware processor causes the hardware processor to perform the following: further comprising causing a next commit instruction to be executed based on the hint for the commit instruction. The data storage device may further store code that when executed by the hardware processor causes the hardware processor to perform the following: wherein the including comprises including the hint as a field of the commit instruction marked for optional execution. The data storage device may further store code that when executed by the hardware processor causes the hardware processor to perform the following: further comprising causing a block of instructions executed out of order before a rollback action to be executed in order after the rollback action. The data storage device may further store code that when executed by the hardware processor causes the hardware processor to perform the following: further comprising causing all commit instructions marked for optional execution of the block of instructions to be executed independently of their hint after the rollback action.

An apparatus may include means for translating an instruction into a translated instruction to be executed by a hardware processor, means for marking a commit instruction one of for execution and for optional execution by the hardware processor, means for including a hint for a commit instruction marked for optional execution, and/or means for determining if the commit instruction marked for optional execution is to be executed based on the hint. An apparatus to selectively execute a commit instruction may be as described in the detailed description. A method for selectively executing a commit instruction may be as described in the detailed description.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (sourcel/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, September 2014; and see Intel® Advanced Vector Extensions Programming Reference, October 2014).

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-Of-Order Core Block Diagram

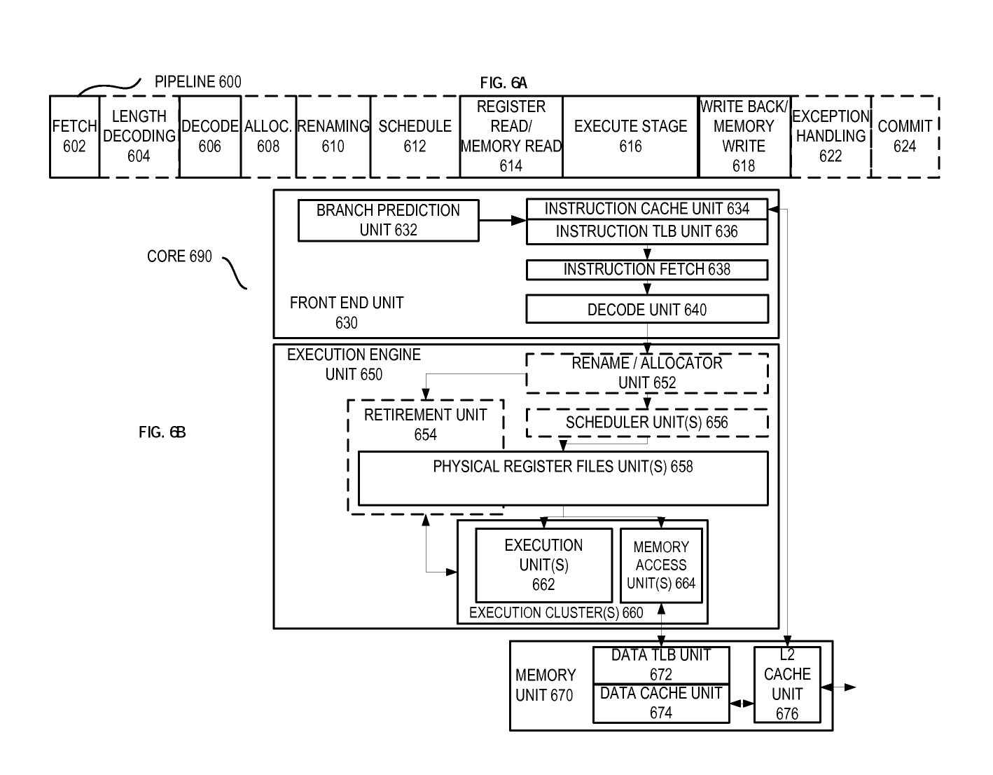

FIG. 6A is a block diagram illustrating both an exemplary in-order pipeline and an exemplary register renaming, out-of-order issue/execution pipeline according to embodiments of the disclosure. FIG. 6B is a block diagram illustrating both an exemplary embodiment of an in-order architecture core and an exemplary register renaming, out-of-order issue/execution architecture core to be included in a processor according to embodiments of the disclosure. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, a length decode stage 604, a decode stage 606, an allocation stage 608, a renaming stage 610, a scheduling (also known as a dispatch or issue) stage 612, a register read/memory read stage 614, an execute stage 616, a write back/memory write stage 618, an exception handling stage 622, and a commit stage 624.

FIG. 6B shows processor core 690 including a front end unit 630 coupled to an execution engine unit 650, and both are coupled to a memory unit 670. The core 690 may be a reduced instruction set computing (RISC) core, a complex instruction set computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front end unit 630 includes a branch prediction unit 632 coupled to an instruction cache unit 634, which is coupled to an instruction translation lookaside buffer (TLB) 636, which is coupled to an instruction fetch unit 638, which is coupled to a decode unit 640. The decode unit 640 (or decoder or decoder unit) may decode instructions (e.g., macro-instructions), and generate as an output one or more micro-operations, micro-code entry points, micro-instructions, other instructions, or other control signals, which are decoded from, or which otherwise reflect, or are derived from, the original instructions. The decode unit 640 may be implemented using various different mechanisms. Examples of suitable mechanisms include, but are not limited to, look-up tables, hardware implementations, programmable logic arrays (PLAs), microcode read only memories (ROMs), etc. In one embodiment, the core 690 includes a microcode ROM or other medium that stores microcode for certain macroinstructions (e.g., in decode unit 640 or otherwise within the front end unit 630). The decode unit 640 is coupled to a rename/allocator unit 652 in the execution engine unit 650.

The execution engine unit 650 includes the rename/allocator unit 652 coupled to a retirement unit 654 and a set of one or more scheduler unit(s) 656. The scheduler unit(s) 656 represents any number of different schedulers, including reservations stations, central instruction window, etc. The scheduler unit(s) 656 is coupled to the physical register file(s) unit(s) 658. Each of the physical register file(s) units 658 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 658 comprises a vector registers unit, a write mask registers unit, and a scalar registers unit. These register units may provide architectural vector registers, vector mask registers, and general purpose registers. The physical register file(s) unit(s) 658 is overlapped by the retirement unit 654 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 654 and the physical register file(s) unit(s) 658 are coupled to the execution cluster(s) 660. The execution cluster(s) 660 includes a set of one or more execution units 662 and a set of one or more memory access units 664. The execution units 662 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 656, physical register file(s) unit(s) 658, and execution cluster(s) 660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 664). It should also be understood that where separate pipelines are used, one or more of these pipelines may be out-of-order issue/execution and the rest in-order.

The set of memory access units 664 is coupled to the memory unit 670, which includes a data TLB unit 672 coupled to a data cache unit 674 coupled to a level 2 (L2) cache unit 676. In one exemplary embodiment, the memory access units 664 may include a load unit, a store address unit, and a store data unit, each of which is coupled to the data TLB unit 672 in the memory unit 670. The instruction cache unit 634 is further coupled to a level 2 (L2) cache unit 676 in the memory unit 670. The L2 cache unit 676 is coupled to one or more other levels of cache and eventually to a main memory.

By way of example, the exemplary register renaming, out-of-order issue/execution core architecture may implement the pipeline 600 as follows: 1) the instruction fetch 638 performs the fetch and length decoding stages 602 and 604; 2) the decode unit 640 performs the decode stage 606; 3) the rename/allocator unit 652 performs the allocation stage 608 and renaming stage 610; 4) the scheduler unit(s) 656 performs the schedule stage 612; 5) the physical register file(s) unit(s) 658 and the memory unit 670 perform the register read/memory read stage 614; the execution cluster 660 perform the execute stage 616; 6) the memory unit 670 and the physical register file(s) unit(s) 658 perform the write back/memory write stage 618; 7) various units may be involved in the exception handling stage 622; and 8) the retirement unit 654 and the physical register file(s) unit(s) 658 perform the commit stage 624.

The core 690 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 690 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 634/674 and a shared L2 cache unit 676, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

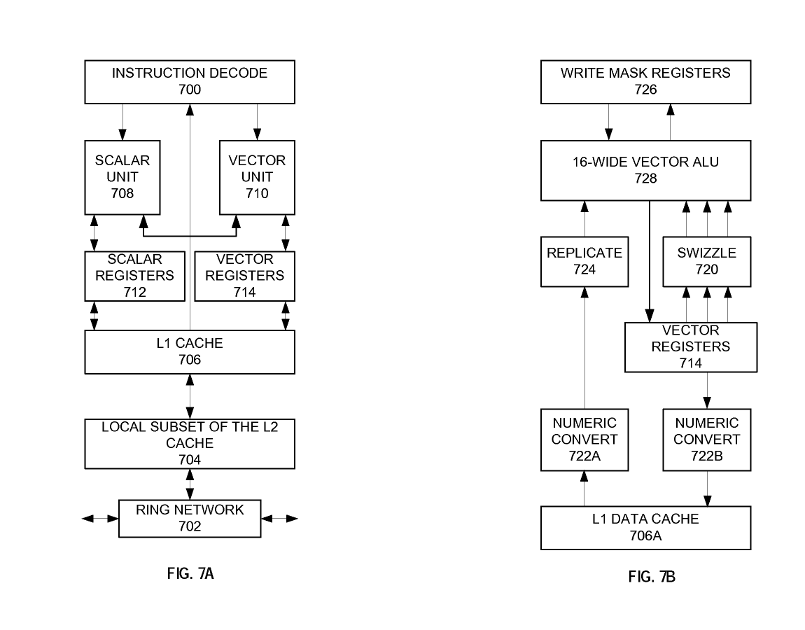

FIGS. 7A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 7A is a block diagram of a single processor core, along with its connection to the on-die interconnect network 702 and with its local subset of the Level 2 (L2) cache 704, according to embodiments of the disclosure. In one embodiment, an instruction decode unit 700 supports the x86 instruction set with a packed data instruction set extension. An L1 cache 706 allows low-latency accesses to cache memory into the scalar and vector units. While in one embodiment (to simplify the design), a scalar unit 708 and a vector unit 710 use separate register sets (respectively, scalar registers 712 and vector registers 714) and data transferred between them is written to memory and then read back in from a level 1 (L1) cache 706, alternative embodiments of the disclosure may use a different approach (e.g., use a single register set or include a communication path that allow data to be transferred between the two register files without being written and read back).

The local subset of the L2 cache 704 is part of a global L2 cache that is divided into separate local subsets, one per processor core. Each processor core has a direct access path to its own local subset of the L2 cache 704. Data read by a processor core is stored in its L2 cache subset 704 and can be accessed quickly, in parallel with other processor cores accessing their own local L2 cache subsets. Data written by a processor core is stored in its own L2 cache subset 704 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 7B is an expanded view of part of the processor core in FIG. 7A according to embodiments of the disclosure. FIG. 7B includes an L1 data cache 706A part of the L1 cache 704, as well as more detail regarding the vector unit 710 and the vector registers 714. Specifically, the vector unit 710 is a 16-wide vector processing unit (VPU) (see the 16-wide ALU 728), which executes one or more of integer, single-precision float, and double-precision float instructions. The VPU supports swizzling the register inputs with swizzle unit 720, numeric conversion with numeric convert units 722A-B, and replication with replication unit 724 on the memory input. Write mask registers 726 allow predicating resulting vector writes.

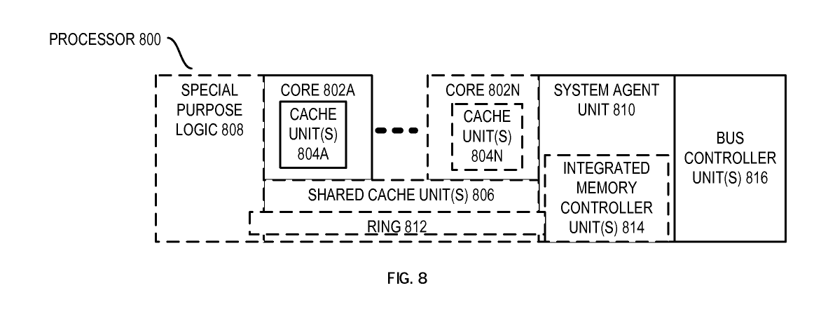

FIG. 8 is a block diagram of a processor 800 that may have more than one core, may have an integrated memory controller, and may have integrated graphics according to embodiments of the disclosure. The solid lined boxes in FIG. 8 illustrate a processor 800 with a single core 802A, a system agent 810, a set of one or more bus controller units 816, while the optional addition of the dashed lined boxes illustrates an alternative processor 800 with multiple cores 802A-N, a set of one or more integrated memory controller unit(s) 814 in the system agent unit 810, and special purpose logic 808.

Thus, different implementations of the processor 800 may include: 1) a CPU with the special purpose logic 808 being integrated graphics and/or scientific (throughput) logic (which may include one or more cores), and the cores 802A-N being one or more general purpose cores (e.g., general purpose in-order cores, general purpose out-of-order cores, a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 806, and external memory (not shown) coupled to the set of integrated memory controller units 814. The set of shared cache units 806 may include one or more mid-level caches, such as level 2 (L2), level 3 (L3), level 4 (L4), or other levels of cache, a last level cache (LLC), and/or combinations thereof. While in one embodiment a ring based interconnect unit 812 interconnects the integrated graphics logic 808, the set of shared cache units 806, and the system agent unit 810/integrated memory controller unit(s) 814, alternative embodiments may use any number of well-known techniques for interconnecting such units. In one embodiment, coherency is maintained between one or more cache units 806 and cores 802-A-N.

In some embodiments, one or more of the cores 802A-N are capable of multi-threading. The system agent 810 includes those components coordinating and operating cores 802A-N. The system agent unit 810 may include for example a power control unit (PCU) and a display unit. The PCU may be or include logic and components needed for regulating the power state of the cores 802A-N and the integrated graphics logic 808. The display unit is for driving one or more externally connected displays.

The cores 802A-N may be homogenous or heterogeneous in terms of architecture instruction set; that is, two or more of the cores 802A-N may be capable of execution the same instruction set, while others may be capable of executing only a subset of that instruction set or a different instruction set.

### Exemplary Computer Architectures

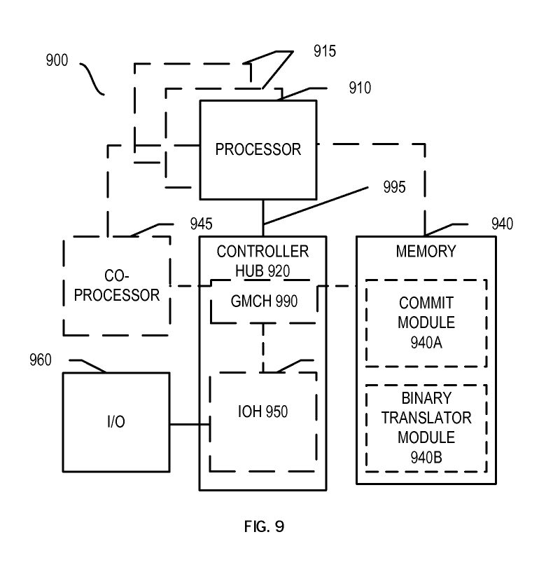

FIGS. 9-12 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 9, shown is a block diagram of a system 900 in accordance with one embodiment of the present disclosure. The system 900 may include one or more processors 910, 915, which are coupled to a controller hub 920. In one embodiment the controller hub 920 includes a graphics memory controller hub (GMCH) 990 and an Input/Output Hub (IOH) 950 (which may be on separate chips); the GMCH 990 includes memory and graphics controllers to which are coupled memory 940 and a coprocessor 945; the IOH 950 is couples input/output (I/O) devices 960 to the GMCH 990. Alternatively, one or both of the memory and graphics controllers are integrated within the processor (as described herein), the memory 940 and the coprocessor 945 are coupled directly to the processor 910, and the controller hub 920 in a single chip with the IOH 950. Memory 940 may include a commit module 940A, for example, to store code that when executed causes a processor to perform any (e.g., commit) method of this disclosure. Memory 940 may include a binary translator module 940B, for example, to store code that when executed causes a processor to perform any (e.g., binary translation) method of this disclosure.

The optional nature of additional processors 915 is denoted in FIG. 9 with broken lines. Each processor 910, 915 may include one or more of the processing cores described herein and may be some version of the processor 800.

The memory 940 may be, for example, dynamic random access memory (DRAM), phase change memory (PCM), or a combination of the two. For at least one embodiment, the controller hub 920 communicates with the processor(s) 910, 915 via a multi-drop bus, such as a frontside bus (FSB), point-to-point interface such as QuickPath Interconnect (QPI), or similar connection 995.

In one embodiment, the coprocessor 945 is a special-purpose processor, such as, for example, a high-throughput MIC processor, a network or communication processor, compression engine, graphics processor, GPGPU, embedded processor, or the like. In one embodiment, controller hub 920 may include an integrated graphics accelerator.

There can be a variety of differences between the physical resources 910, 915 in terms of a spectrum of metrics of merit including architectural, microarchitectural, thermal, power consumption characteristics, and the like.

In one embodiment, the processor 910 executes instructions that control data processing operations of a general type. Embedded within the instructions may be coprocessor instructions. The processor 910 recognizes these coprocessor instructions as being of a type that should be executed by the attached coprocessor 945. Accordingly, the processor 910 issues these coprocessor instructions (or control signals representing coprocessor instructions) on a coprocessor bus or other interconnect, to coprocessor 945. Coprocessor(s) 945 accept and execute the received coprocessor instructions.

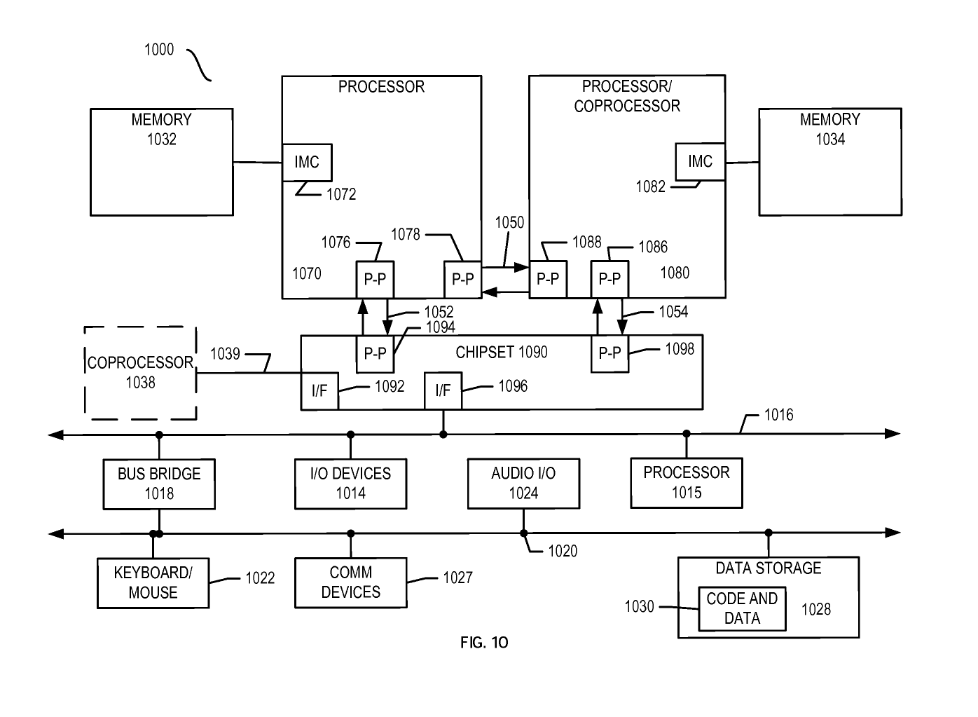

Referring now to FIG. 10, shown is a block diagram of a first more specific exemplary system 1000 in accordance with an embodiment of the present disclosure. As shown in FIG. 10, multiprocessor system 1000 is a point-to-point interconnect system, and includes a first processor 1070 and a second processor 1080 coupled via a point-to-point interconnect 1050. Each of processors 1070 and 1080 may be some version of the processor 800. In one embodiment of the disclosure, processors 1070 and 1080 are respectively processors 910 and 915, while coprocessor 1038 is coprocessor 945. In another embodiment, processors 1070 and 1080 are respectively processor 910 coprocessor 945.

Processors 1070 and 1080 are shown including integrated memory controller (IMC) units 1072 and 1082, respectively. Processor 1070 also includes as part of its bus controller units point-to-point (P-P) interfaces 1076 and 1078; similarly, second processor 1080 includes P-P interfaces 1086 and 1088. Processors 1070, 1080 may exchange information via a point-to-point (P-P) interface 1050 using P-P interface circuits 1078, 1088. As shown in FIG. 10, IMCs 1072 and 1082 couple the processors to respective memories, namely a memory 1032 and a memory 1034, which may be portions of main memory locally attached to the respective processors.

Processors 1070, 1080 may each exchange information with a chipset 1090 via individual P-P interfaces 1052, 1054 using point to point interface circuits 1076, 1094, 1086, 1098. Chipset 1090 may optionally exchange information with the coprocessor 1038 via a high-performance interface 1039. In one embodiment, the coprocessor 1038 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1090 may be coupled to a first bus 1016 via an interface 1096. In one embodiment, first bus 1016 may be a Peripheral Component Interconnect (PCI) bus, or a bus such as a PCI Express bus or another third generation I/O interconnect bus, although the scope of the present disclosure is not so limited.

As shown in FIG. 10, various I/O devices 1014 may be coupled to first bus 1016, along with a bus bridge 1018 which couples first bus 1016 to a second bus 1020. In one embodiment, one or more additional processor(s) 1015, such as coprocessors, high-throughput MIC processors, GPGPU's, accelerators (such as, e.g., graphics accelerators or digital signal processing (DSP) units), field programmable gate arrays, or any other processor, are coupled to first bus 1016. In one embodiment, second bus 1020 may be a low pin count (LPC) bus. Various devices may be coupled to a second bus 1020 including, for example, a keyboard and/or mouse 1022, communication devices 1027 and a storage unit 1028 such as a disk drive or other mass storage device which may include instructions/code and data 1030, in one embodiment. Further, an audio I/O 1024 may be coupled to the second bus 1020. Note that other architectures are possible. For example, instead of the point-to-point architecture of FIG. 10, a system may implement a multi-drop bus or other such architecture.

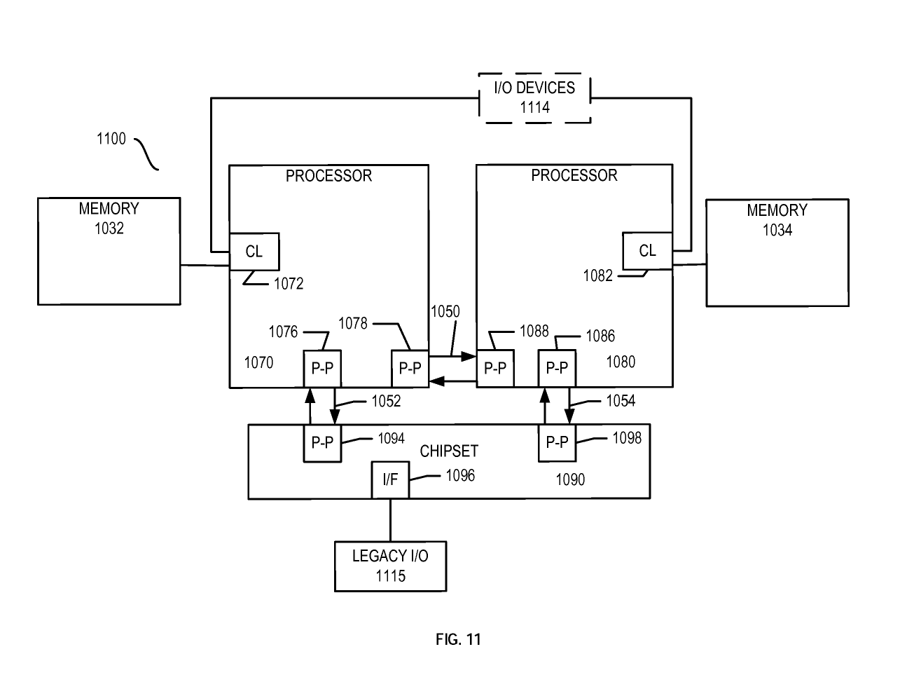

Referring now to FIG. 11, shown is a block diagram of a second more specific exemplary system 1100 in accordance with an embodiment of the present disclosure. Like elements in FIGS. 10 and 11 bear like reference numerals, and certain aspects of FIG. 10 have been omitted from FIG. 11 in order to avoid obscuring other aspects of FIG. 11.

FIG. 11 illustrates that the processors 1070, 1080 may include integrated memory and I/O control logic (“CL”) 1072 and 1082, respectively. Thus, the CL 1072, 1082 include integrated memory controller units and include I/O control logic. FIG. 11 illustrates that not only are the memories 1032, 1034 coupled to the CL 1072, 1082, but also that I/O devices 1114 are also coupled to the control logic 1072, 1082. Legacy I/O devices 1115 are coupled to the chipset 1090.

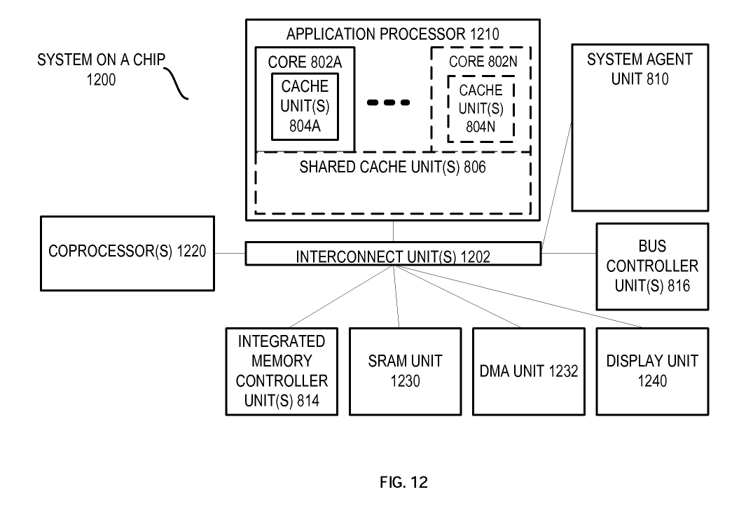

Referring now to FIG. 12, shown is a block diagram of a SoC 1200 in accordance with an embodiment of the present disclosure. Similar elements in FIG. 8 bear like reference numerals. Also, dashed lined boxes are optional features on more advanced SoCs. In FIG. 12, an interconnect unit(s) 1202 is coupled to: an application processor 1210 which includes a set of one or more cores 202A-N and shared cache unit(s) 806; a system agent unit 810; a bus controller unit(s) 816; an integrated memory controller unit(s) 814; a set or one or more coprocessors 1220 which may include integrated graphics logic, an image processor, an audio processor, and a video processor; an static random access memory (SRAM) unit 1230; a direct memory access (DMA) unit 1232; and a display unit 1240 for coupling to one or more external displays. In one embodiment, the coprocessor(s) 1220 include a special-purpose processor, such as, for example, a network or communication processor, compression engine, GPGPU, a high-throughput MIC processor, embedded processor, or the like.

Embodiments (e.g., of the mechanisms) disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 1030 illustrated in FIG. 10, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

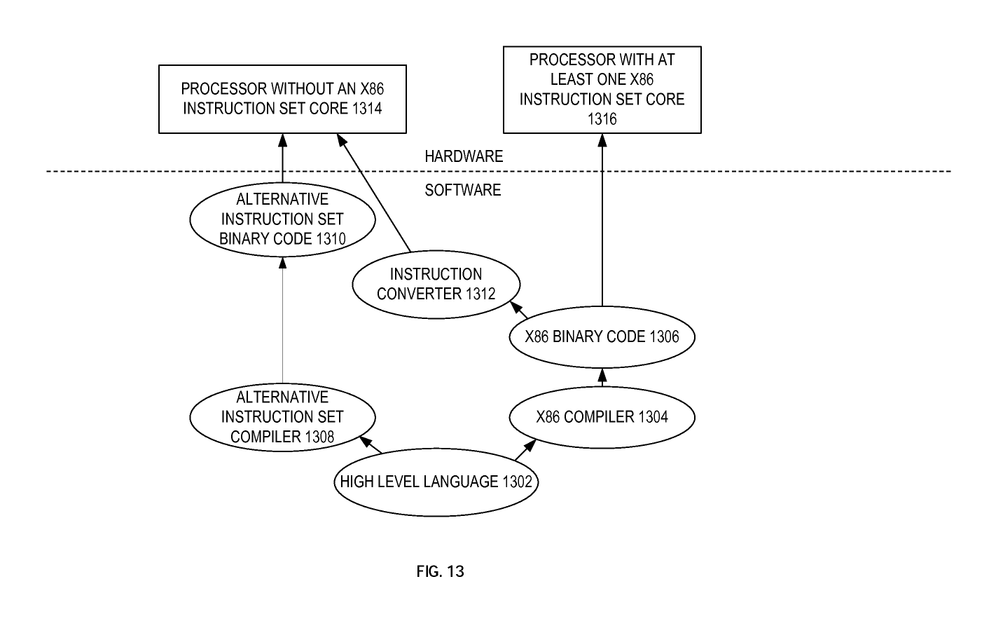

FIG. 13 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 13 shows a program in a high level language 1302 may be compiled using an x86 compiler 1304 to generate x86 binary code 1306 that may be natively executed by a processor with at least one x86 instruction set core 1316. The processor with at least one x86 instruction set core 1316 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1304 represents a compiler that is operable to generate x86 binary code 1306 (e.g., object code) that can, with or without additional linkage processing, be executed on the processor with at least one x86 instruction set core 1316. Similarly, FIG. 13 shows the program in the high level language 1302 may be compiled using an alternative instruction set compiler 1308 to generate alternative instruction set binary code 1310 that may be natively executed by a processor without at least one x86 instruction set core 1314 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1312 is used to convert the x86 binary code 1306 into code that may be natively executed by the processor without an x86 instruction set core 1314. This converted code is not likely to be the same as the alternative instruction set binary code 1310 because an instruction converter capable of this is difficult to make; however, the converted code will accomplish the general operation and be made up of instructions from the alternative instruction set. Thus, the instruction converter 1312 represents software, firmware, hardware, or a combination thereof that, through emulation, simulation or any other process, allows a processor or other electronic device that does not have an x86 instruction set processor or core to execute the x86 binary code 1306.

What is claimed is:

1. An apparatus comprising:
a hardware binary translator to:
translate an instruction into a translated instruction to be executed by a hardware processor;
mark a commit instruction one of for execution and for optional execution by the hardware processor;
and
include a hint for a commit instruction marked for optional execution; and
a hardware commit unit to determine if the commit instruction marked for optional execution is to be executed based on the hint.

2. The apparatus of claim 1, wherein the translated instruction follows the commit instruction in program order.

3. The apparatus of claim 1, wherein the hardware commit unit is to cause a next commit instruction to be executed based on the hint for the commit instruction.

4. The apparatus of claim 1, wherein the hardware binary translator is to include the hint as a field of the commit instruction marked for optional execution.

5. The apparatus of claim 1, wherein the hardware commit unit is to cause a block of instructions executed out of order before a rollback action to be executed in order after the rollback action.

6. The apparatus of claim 5, wherein the hardware commit unit is to cause all commit instructions marked for optional execution of the block of instructions to be executed independently of their hint after the rollback action.

7. An apparatus comprising:
a data storage device that stores code that when executed by a hardware processor causes the hardware processor to perform the following:
translating an instruction into a translated instruction to be executed by the hardware processor;
marking a commit instruction one of for execution and for optional execution by the hardware processor; and
including a hint for a commit instruction marked for optional execution; and
a hardware commit unit to determine if the commit instruction marked for optional execution is to be executed based on the hint.

8. The apparatus of claim 7, wherein the translated instruction follows the commit instruction in program order.

9. The apparatus of claim 7, wherein the data storage device further stores code that when executed by the hardware processor causes the hardware processor to perform the following:
causing a next commit instruction to be executed based on the hint for the commit instruction.

10. The apparatus of claim 7, wherein the data storage device further stores code that when executed by the hardware processor causes the hardware processor to perform the following:
wherein the including comprises including the hint as a field of the commit instruction marked for optional execution.

11. The apparatus of claim 7, wherein the data storage device further stores code that when executed by the hardware processor causes the hardware processor to perform the following:
causing a block of instructions executed out of order before a rollback action to be executed in order after the rollback action.

12. The apparatus of claim 11, wherein the data storage device further stores code that when executed by the hardware processor causes the hardware processor to perform the following:
causing all commit instructions marked for optional execution of the block of instructions to be executed independently of their hint after the rollback action.

13. A method comprising:
translating an instruction into a translated instruction to be executed by a hardware processor;
marking a commit instruction one of for execution and for optional execution by the hardware processor;
including a hint for a commit instruction marked for optional execution; and
determining if the commit instruction marked for optional execution is to be executed based on the hint.

14. The method of claim 13, wherein the translated instruction follows the commit instruction in program order.

15. The method of claim 13, further comprising causing a next commit instruction to be executed based on the hint for the commit instruction.

16. The method of claim 13, wherein the including comprises including the hint as a field of the commit instruction marked for optional execution.

17. The method of claim 13, further comprising causing a block of instructions executed out of order before a rollback action to be executed in order after the rollback action.

18. The method of claim 17, further comprising causing all commit instructions marked for optional execution of the block of instructions to be executed independently of their hint after the rollback action.

19. An apparatus comprising:
a hardware processor; and
a data storage device that stores code that when executed by the hardware processor causes the hardware processor to perform the following:
translating an instruction into a translated instruction to be executed by the hardware processor;
marking a commit instruction one of for execution and for optional execution by the hardware processor;
including a hint for a commit instruction marked for optional execution; and
determining if the commit instruction marked for optional execution is to be executed based on the hint.

20. The apparatus of claim 19, wherein the translated instruction follows the commit instruction in program order.

21. The apparatus of claim 19, wherein the data storage device further stores code that when executed by the hardware processor causes the hardware processor to perform the following:
further comprising causing a next commit instruction to be executed based on the hint for the commit instruction.

22. The apparatus of claim 19, wherein the data storage device further stores code that when executed by the hardware processor causes the hardware processor to perform the following:
wherein the including comprises including the hint as a field of the commit instruction marked for optional execution.

23. The apparatus of claim 19, wherein the data storage device further stores code that when executed by the hardware processor causes the hardware processor to perform the following:
further comprising causing a block of instructions executed out of order before a rollback action to be executed in order after the rollback action.

24. The apparatus of claim 23, wherein the data storage device further stores code that when executed by the hardware processor causes the hardware processor to perform the following:
further comprising causing all commit instructions marked for optional execution of the block of instructions to be executed independently of their hint after the rollback action.
